(19) United States
(12) Patent Application Publication
(10) Pub. No.: US 2009/0066865 A1
(43) Pub. Date: Mar. 12, 2009

(54) SIGNAL GENERATION APPARATUS FOR LIQUID CRYSTAL DISPLAY DEVICE

(76) Inventors: Sun-Man So, Seocho-gu (KR); Jong-Kea Kim, Suwon-si (KR)

Correspondence Address: SHERR & VAUGHN, PLLC, 620 HERNDON PARKWAY, SUITE 200, HERNDON, VA, 20170, US

(21) Appl. No.: 12/207,550

(22) Filed: Sep. 10, 2008

(30) Foreign Application Priority Data
Sep. 12, 2007 (KR) 10-2007-00092751

(51) Int. Cl. G02F 1/133

(52) U.S. Cl. 349/33

(57) ABSTRACT

A signal generation apparatus for a liquid crystal display device includes a pingpong frame controller (PFC) for generating and outputting a signal alternating at intervals of two frames using a signal having a blank period for discrimination between frames, a pingpong line controller (PLC) for generating and outputting a signal alternating at intervals of two lines using the signal having the blank period, and a pingpong control (PPC) signal generator for performing a logic operation with respect to the output signal from the PLC and the output signal from the PFC to generate a pingpong control signal. Therefore, it is possible to generate the pingpong control signal for offset removal without an additional wiring for a frame indication signal on a PCB, thereby not only curtailing a production cost, but also reducing circuit complexity and providing a picture of excellent quality.

The present application claims priority under 35 U.S.C. §119 to Korean Patent Application No. 10-2007-0092751 (filed on Sep. 12, 2007), which is hereby incorporated by reference in its entirety.

### BACKGROUND

Liquid crystal display devices, among flat panel display devices, have been popular consumer electronic devices due to its low power consumption, excellent portability, and adaptability. A liquid crystal display device has a liquid crystal interposed between an array substrate on which thin film transistors are formed and a color filter substrate. The liquid display device is driven in such a manner that it obtains an image effect using a difference between refractive indexes of the liquid crystal based on the anisotropy of the liquid crystal. Presently, great attention is given to an active matrix liquid crystal display (AM-LCD) which exhibits excellent resolution and excellent moving image display capability. In an AM-LCD, pixel electrodes, or lower transparent electrodes for applying signal voltages to thin film transistors and liquid crystal layers, are arranged in matrix form. The AM-LCD is widely used in a monitor of a notebook computer, etc, and has a panel which is driven by a source driver and a gate driver.

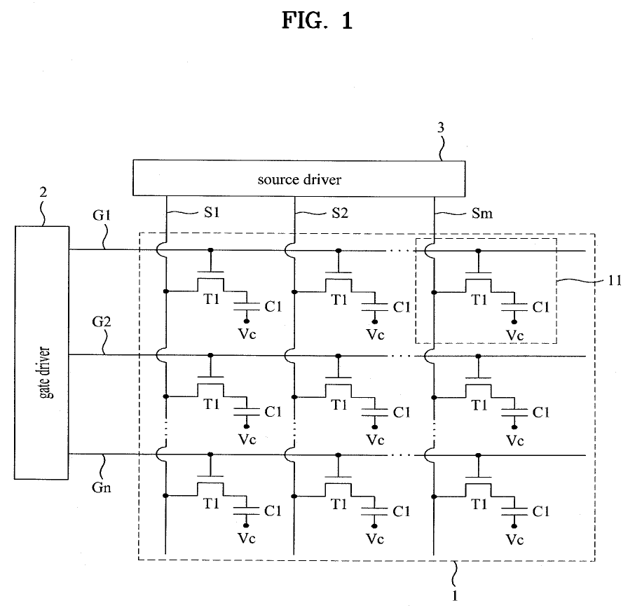

As illustrated in example FIG. 1, a thin-film transistor liquid crystal display device (TFT-LCD) may include liquid crystal panel 1, gate driver 2 and source driver 3. Liquid crystal panel 1 includes a plurality of pixels 11, each of which is modeled by liquid crystal capacitor C1 and switch T1. Gate driver 2 turns on/off the gates of switches T1 through a plurality of gate lines G1, G2, . . . , Gn. Source driver 3 outputs a gray scale voltage through a corresponding one of source lines S1, S2, . . . , Sm based on input data. That is, when switches T1 connected to a corresponding one of gate lines G1, G2, . . . , Gn are turned on by an output voltage from gate driver 2, the gray scale voltage outputted from source driver 3 is applied to a corresponding one of liquid crystal capacitors C1 connected to the turned-on switches. On the other hand, an offset removing or reducing method is used in a driver for such a liquid crystal display device to improve a picture quality. One such method is a pingpong method that additionally provides a switch in an analog buffer included in a driver to efficiently improve an offset characteristic.

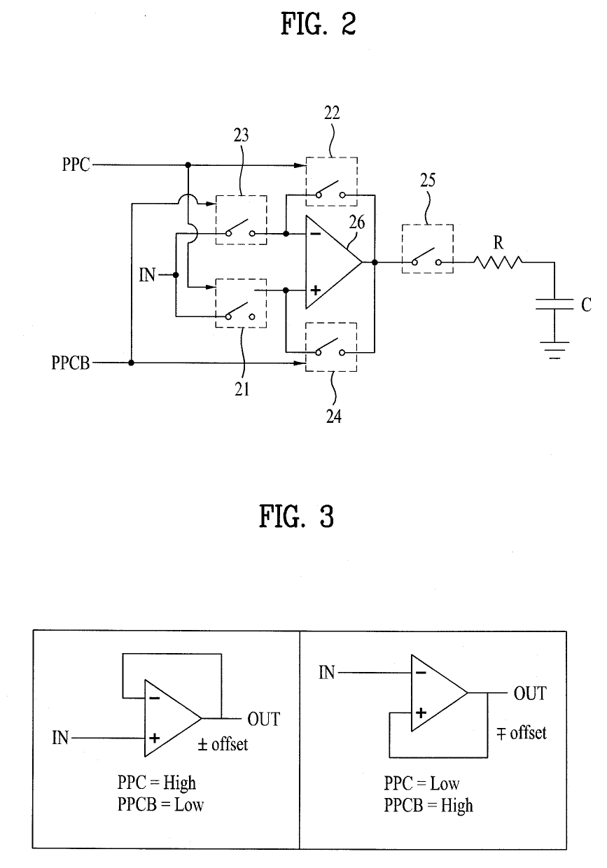

Example FIG. 2 illustrates a buffer circuit with a pingpong function included in a driver, while example FIG. 3 illustrates offset polarities based on a pingpong control signal.

As illustrated in example FIG. 2, the buffer circuit having the pingpong function includes first, second, third and fourth switches 21, 22, 23 and 24 operating in response to pingpong control signal PPC or inverted pingpong control signal PPCB, fifth switch 25 at an output stage, differential amplifier 26, and resistor R and capacitor C connected to fifth switch 25 at the output stage. In this buffer circuit, first and second switches 21 and 22 are driven by pingpong control signal PPC and third and fourth switches 23 and 24 are driven by inverted pingpong control signal PPCB.

As illustrated in example FIGS. 2 and 3, the polarity of an offset of the buffer circuit is changed by applying pingpong control signal PPC of a high logic level and inverted pingpong control signal PPCB of a low logic level to the buffer circuit and then applying pingpong control signal PPC of the low logic level and inverted pingpong control signal PPCB of the high logic level to the buffer circuit. That is, an offset of the buffer circuit is visually removed by applying a positive offset to the buffer circuit one time and applying a negative offset to the buffer circuit another time. In order to realize this function, it is necessary to generate the switch control signal, or pingpong control signal PPC. This signal generation can be performed on the premise that a frame recognition signal is present. In general, a display screen displays 60 pictures per sec. (60 Hz), each of which is typically called a “frame.” A gate start pulse (GSP) signal, which indicates the start of a frame, has been used as pingpong control signal PPC. Because the GSP signal is generally used to remove the driver offset, as mentioned above, a pin must be additionally provided in the source driver and, moreover, a signal wiring must be additionally provided in a printed circuit board (PCB), resulting in an increase in circuit complexity and overall costs.

### SUMMARY

Embodiments relate to a signal generation apparatus for a liquid crystal display device for generating a pingpong control signal for removal of an offset of a driver which drives the liquid crystal display device.

Embodiments relate to a signal generation apparatus for a liquid crystal display device which generates a source driver offset control signal, or pingpong control signal, based on a signal having a blank period without separately using an additional signal.

Embodiments relate to a signal generation apparatus for a liquid crystal display device which generates a pingpong control signal for removal of an offset of the liquid crystal display device, the apparatus including at least one of the following: a pingpong frame controller (PFC) for generating and outputting a signal alternating at intervals of two frames using a signal having a blank period for discrimination between frames; a pingpong line controller (PLC) for generating and outputting a signal alternating at intervals of two lines using the signal having the blank period; and a pingpong control (PPC) signal generator for performing a logic operation with respect to the output signal from the PLC and the output signal from the PFC to generate the pingpong control signal.

Embodiments relate to a signal generation apparatus for a liquid crystal display device for generating a pingpong control signal for removal of an offset of the liquid crystal display device, the apparatus including at least one of the following steps: a frame recognizer for generating a frame recognition signal from a signal having a blank period for discrimination between frames; a pingpong frame controller (PFC) for converting the frame recognition signal into a signal alternating at intervals of a certain number of frames and outputting the converted signal; a pingpong line controller (PLC) for generating and outputting a signal alternating at intervals of a certain number of lines using the signal having the blank period; and a pingpong control (PPC) signal generator for performing a logic operation with respect to the output signal from the PLC and the output signal from the PFC to generate the pingpong control signal.

### DRAWINGS

Example FIG. 1 illustrates a TFT-LCD.

Example FIGS. 2 and 3 illustrate a circuit diagram of a buffer circuit with a pingpong function included in a driver and offset polarities based on a pingpong control signal.

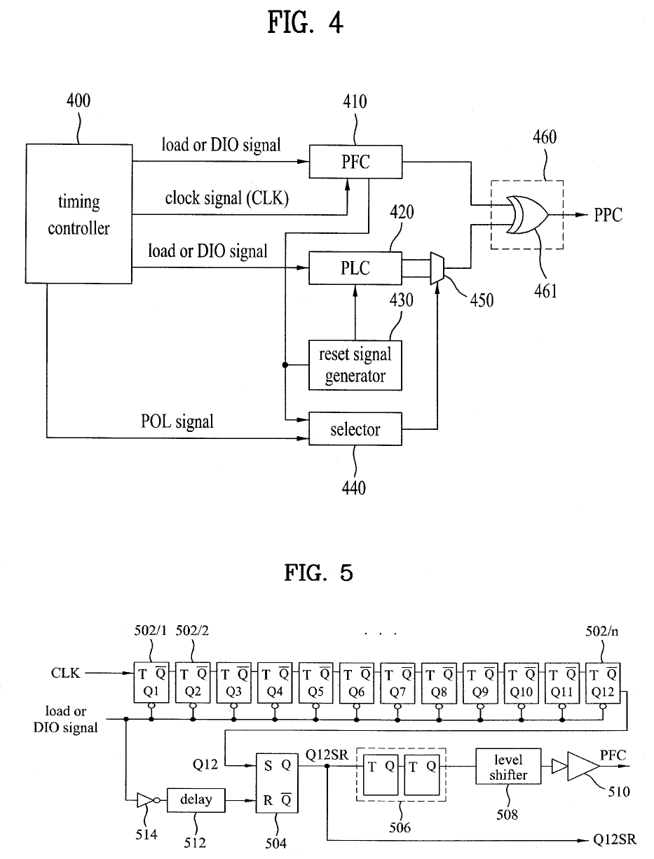

Example FIG. 4 illustrates a signal generation apparatus for generating a pingpong control signal for removal of a display offset, in accordance with embodiments.

Example FIG. 5 illustrates a pingpong frame controller (PFC) in accordance with embodiments.

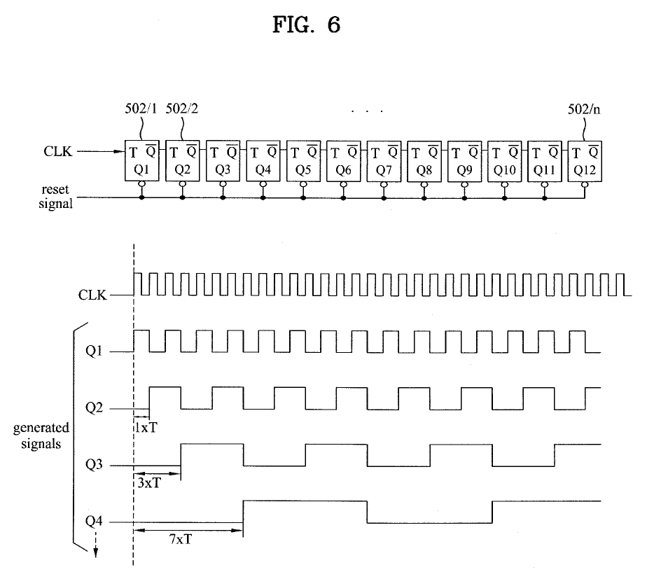

Example FIG. 6 illustrates a waveform diagram of the outputs of counters illustrated in example FIG. 5.

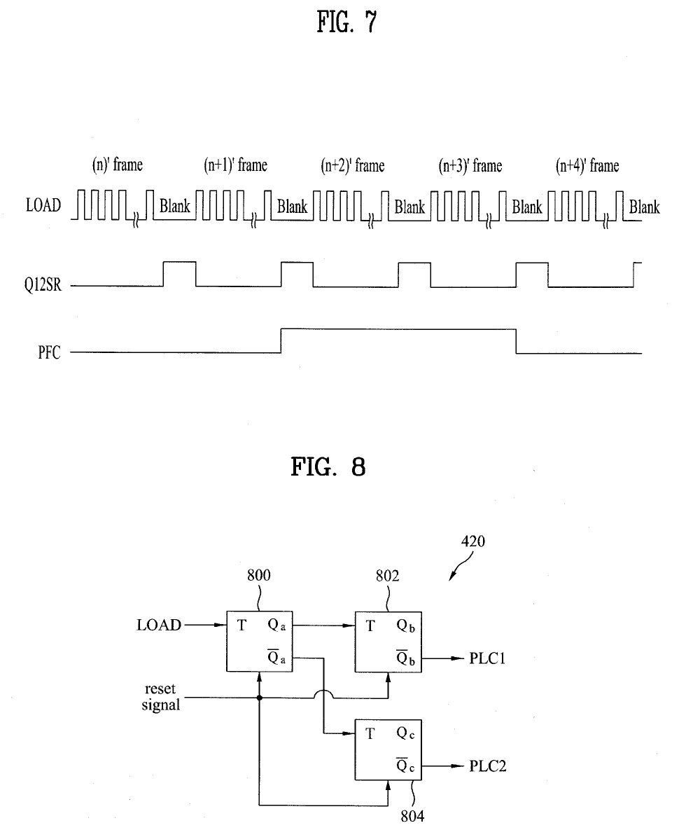

Example FIG. 7 illustrates a waveform diagram of signals of respective components of the PFC illustrated in example FIG. 5.

Example FIG. 8 illustrates a pingpong line controller (PLC) in accordance with embodiments.

Example FIG. 9 illustrates a waveform diagram of signals of respective components of the pingpong line controller (PLC) illustrated in example FIG. 8.

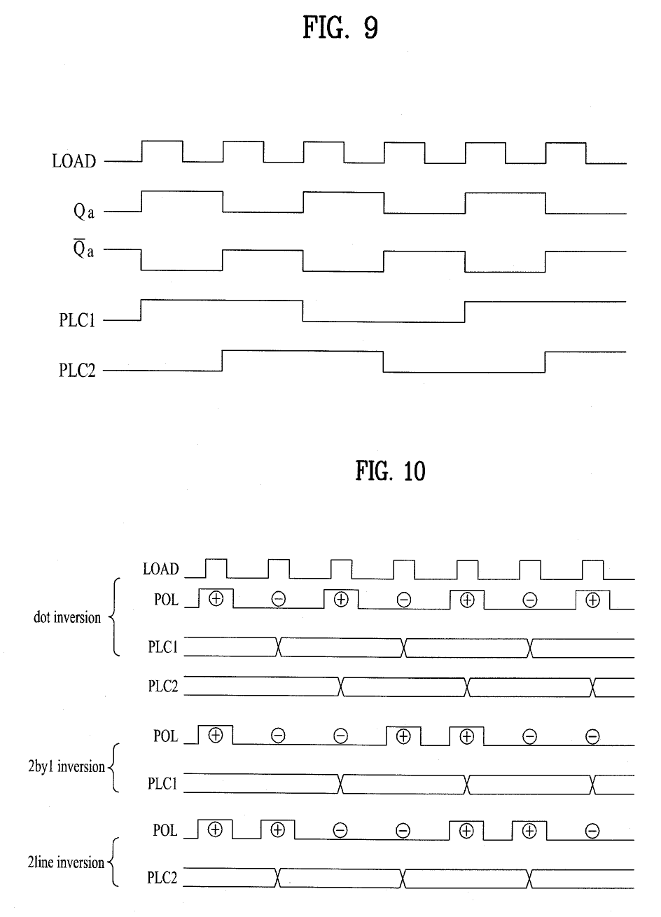

Example FIG. 10 illustrates a waveform diagram illustrating the operation of a pingpong line controller (PLC) in accordance with embodiments.

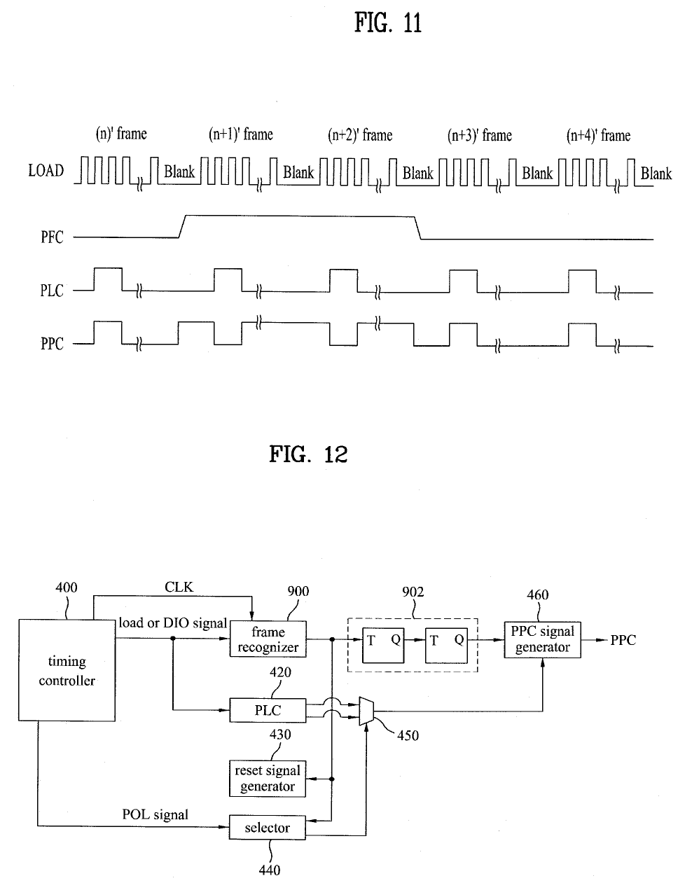

Example FIG. 11 illustrates a waveform diagram of input and output signals of a pingpong control (PPC) signal generator in accordance with embodiments.

Example FIG. 12 illustrates a signal generation apparatus for generating a pingpong control signal for removal of a display offset, in accordance with embodiments.

### DESCRIPTION

Reference will now be made in detail to embodiments, examples of which are illustrated in the accompanying drawings. Wherever possible, the same reference numbers will be used throughout the drawings to refer to the same or like parts. In the following description of embodiments, a detailed description of known functions and configurations incorporated herein will be omitted when it may make embodiments rather unclear.

As illustrated in example FIG. 4, a signal generation apparatus in accordance with embodiments may include timing controller 400, pingpong frame controller (PFC) 410, pingpong line controller (PLC) 420, reset signal generator 430, selector 440, signal selector 450, and pingpong control (PPC) signal generator 460. The components of the apparatus illustrated in example FIG. 4, except timing controller 400, may be included in source driver 3 illustrated in example FIG. 1. Timing controller 400 generates a digital input/output (DIO) signal or a load signal LOAD, which is a latch signal, and a POL signal, which is a polarity signal. Here, the load signal is a signal that instructs application of a digital/analog-converted data signal to a liquid crystal panel, and the DIO signal signifies a data start pulse in a reduced swing differential signaling (RSDS) scheme, which is a start pulse signal for control of data signals to be sequentially distributed as the data signals are connected in a point-to-point connection manner and latched by an operation clock signal. It may be assumed here that timing controller 400 of does not generate the load signal or DIO signal for a blank period of several hundred μs after providing signals corresponding to one frame to a source driver and a gate driver, namely, spreading all the signals on one picture. In this regard, the load signal or DIO signal has the blank period for discrimination between frames.

As illustrated in example FIG. 5, PFC 410 functions to generate a signal alternating at intervals of two frames, namely, a signal having a period of four frames using the load signal or DIO signal. PFC 410 may include a plurality of counters 502/1, 502/2, . . . , 502/n, first logic circuit 504, second logic circuit 506, level shifter 508, buffer 510, delay 512 and inverter 514. The load signal LOAD or DIO signal is provided as a reset signal to each of counters 502/1, 502/2, . . . , 502/n. Here, the reset signal may be “0” or “1” to initialize each counter 502/1, 502/2, . . . , 502/n. The load signal LOAD or DIO signal is also input to inverter 514. When the load signal LOAD or DIO signal is “0”, a signal having a logic level of “1” is provided to first logic circuit 504 through inverter 514. The plurality of counters 502/1, 502/2, . . . , 502/n are connected in series and initialized by the load signal or DIO signal having the blank period. Each counter 502/1, 502/2, . . . , 502/n makes a transition of period T of a clock signal by (2ⁿ⁻¹−1) times so that counters 502/1, 502/2, . . . , 502/n convert the clock signal into a signal having a period of 2ⁿT and output the converted signal.

As illustrated in example FIG. 6, first counter 502/1 makes a transition of period T of a clock signal CLK by (2ⁿ⁻¹1) times to convert the clock signal CLK into a signal having a period of 2T, and outputs the converted signal to second counter 502/2. Here, because n=1, the transition of the period T of the clock signal CLK is made by Ons. Second counter 502/2 makes a transition of the period T of the clock signal CLK by (2ⁿ⁻¹−1) times to convert the clock signal CLK into a signal having a period of 4T, and outputs the converted signal to third counter 502/3. Here, because n=2, the transition of the period T of the clock signal CLK is made by Tns. The nth counter 502/n makes a transition of the period T of the clock signal CLK by (2ⁿ⁻¹−1)Tns to convert the clock signal CLK into a signal having a period of 2ⁿT, and outputs the converted signal as a signal Q12 to first logic circuit 504. Here, the number, n, of the counters is a positive number which is larger than the maximum period of the load signal or DIO signal depending on the resolution and frequency of a liquid crystal display device. That is, the number n of the counters is determined to be a positive integer satisfying conditions of the following equation 1:

(2ⁿ⁻¹−1)×T>max(Tₗᵢₙₑ₋ₜᵢₘₑ) Equation 1

Here, max(T^{line-time}) signifies the maximum period of a line time. Also, the counter number n must be set such that (2ⁿ⁻¹−1)×T is smaller than the blank period. On the other hand, counters 502/1, 502/2, . . . , 502/n are initialized based on the load signal or DIO signal generated from timing controller 400 or the inverted signal thereof, as stated previously. For example, each counter 502/1, 502/2, . . . , 502/n may be implemented with a T flip-flop, as illustrated in example FIG. 6.

First logic circuit 504 is a logic device that receives output signal Q12 from the nth counter 502/n and an output signal from delay 512 and thereby outputs a signal Q12SR. For example, logic circuit 504 may be implemented with an SR flip-flop. First logic circuit 504 outputs the signal Q12SR at a positive output terminal Q thereof upon receiving signal Q12 at a set terminal S thereof, and is initialized upon receiving a signal of “1” at a reset terminal R thereof. Here, delay 512 is installed upstream of the reset terminal R such that both signals inputted to the set terminal S and reset terminal R are not “1.” When the output signal from inverter 514 is “1,” delay 512 delays the output signal from inverter 514 by a predetermined time and outputs the delayed signal to the reset terminal R. On the other hand, when the load signal or DIO signal is “0,” it is inverted by inverter 514 and then inputted to the reset terminal R through delay 512.

As illustrated in example FIG. 7, in accordance with embodiments, in order to generate a signal PFC alternating at intervals of two frames, first logic circuit 504 outputs the signal Q12SR for recognition of the blank period of the load signal LOAD to second logic circuit 506. One period of the signal Q12SR is one frame. Second logic circuit 506 is composed of two flip-flops, for example, two T flip-flops connected in series to convert the signal Q12SR into a signal alternating at intervals of two frames and output the converted signal. The level of the signal alternating at intervals of two frames is converted into a voltage level capable of turning on or off pingpong control switches 21, 22, 23 and 24 of example FIG. 2, through level shifter 508. The resulting signal PFC outgoing from PFC 410 alternately changes an offset polarity with respect to each pixel, thereby enabling temporal averaging. PLC 420 generates a pingpong control signal with (alternately) changing an offset polarity between adjacent pixels in one frame to enable spatial averaging. PLC 420 may be implemented with first, second and third logic devices. The first logic device receives the load signal or DIO signal having the blank period and outputs a positive output signal having a level alternately changing at intervals of one line, and a negative output signal which is an inverted signal of the positive output signal. The second logic device receives the positive output signal outputted from the first logic device and outputs first signal PLC1 having a level alternating at intervals of two lines beginning with a third line. The third logic device receives the negative output signal outputted from the first logic device and outputs second signal PLC2 having a level alternating at intervals of two lines beginning with a second line. The first, second and third logic devices may be implemented with T flip-flops 800, 802 and 804, respectively. Consequently, PLC 420 receives a signal having the blank period, namely, the load signal LOAD and generates and outputs signals PLC1 and PLC2 each having a level alternately changing at intervals of two lines.

Example FIG. 8 illustrates PLC 420 illustrated in example FIG. 4. As illustrated herein, PLC 420 includes three T flip-flops 800, 802 and 804. As illustrated in example FIG. 8, T flip-flip 800 of PLC 420 receives the load signal LOAD at an input terminal T thereof, and outputs a signal having twice the period of the load signal LOAD at positive output terminal Qₐ thereof and outputs an inverted signal of the signal at positive output terminal Qₐ at negative output terminal \tilde{Q}ₐ thereof. T flip-flop 802 receives the output signal from positive output terminal Qₐ of T flip-flop 800 at an input terminal T thereof, and outputs the signal PLC1 at negative output terminal \tilde{Q}_{b} thereof. T flip-flop 804 receives the output signal from negative output terminal \tilde{Q}ₐ of T flip-flop 800 at an input terminal T thereof, and outputs signal PLC2 at negative output terminal \tilde{Q}_{c} thereof.

As illustrated in example FIG. 9, T flip-flop 800 outputs a signal rising at a first rising edge of the load signal and falling at a second rising edge of the load signal, namely, a signal having a level alternately changing at intervals of one line at positive output terminal Qₐ thereof and outputs an inverted signal of the signal at positive output terminal Qₐ at negative output terminal \tilde{Q}ₐ thereof. As a result, as illustrated in example FIG. 9, the signal PLC1 alternating beginning with the third line can be outputted through negative output terminal \tilde{Q}_{b} of T flip-flop 802, and the signal PLC2 alternating beginning with the second line can be outputted through negative output terminal \tilde{Q}_{c} of T flip-flop 804. Each T flip-flop 800, 802 and 804 of PLC 420 is initialized by a reset signal generated from reset signal generator 430. Reset signal generator 430 generates the reset signal in a period from the end of the blank period until the input of the load signal LOAD of the next frame in response to a signal for recognition of the blank period, for example, the signal Q12SR illustrated in example FIG. 7 input from PFC 410. This reset signal is generated at intervals of one frame. That is, reset signal generator 430 receives the blank period recognition signal Q12SR and generates the reset signal for initialization of PLC 420 at intervals of one frame. As a result, PLC 420 generates the same signal in every frame. Selector 440 generates a selection control signal through a comparison between POL signal polarities of the first line and second line using the POL signal generated from timing controller 400 and the signal Q12SR outputted from PFC 410. That is, selector 440 determines an inversion form of the POL signal and outputs a selection control signal for selection of any one of the signals PLC1 and PLC2 output from PLC 420 to signal selector 450 as a result of the determination.

As illustrated in example FIG. 10, in the case where the POL signal polarities of the first line and second line are different, selector 440 determines the mode of the liquid crystal display device to be a dot inversion mode or 2-by-1 inversion mode, and outputs a selection control signal for selection of the signal PLC1. Conversely, in the case where the POL signal polarities of the first line and second line are the same, selector 440 determines the mode of the liquid crystal display device to be a 2-line inversion mode, and outputs a selection control signal for selection of the signal PLC2. Signal selector 450 is a multiplexer that selects any one of the signals PLC1 and PLC2 output from PLC 420 in response to the selection control signal from selector 440. Signal selector 450 outputs the selected signal PLC to PPC signal generator 460.

As illustrated in example FIG. 11, PPC signal generator 460 may be implemented with exclusive-OR gate 461 for receiving the signal PFC alternating at intervals of two frames, output from PFC 410, and the signal PLC alternating at intervals of two lines, generated by PLC 420 and output through signal selector 450, and exclusive-ORing the received signals. PPC signal generator 460 outputs a final pingpong control signal PPC through the exclusive-OR operation between the signal PFC and the signal PLC. That is, PPC signal generator 460 generates the final signal PPC such that two offset removal algorithms, a frame-unit algorithm and a pixel-unit algorithm, can operate at the same time. This signal PPC is output to the buffer circuit with the pingpong function illustrated in example FIG. 2.

In conclusion, the signal generation apparatus for the liquid crystal display device in accordance with embodiments generates a signal alternating at intervals of two frames and a signal alternating at intervals of two lines using a signal having a blank period, namely, a load signal or DIO signal and then generate a pingpong control signal based on the generated signals. Therefore, it is possible to generate the pingpong control signal for offset removal without an additional wiring on a PCB, thereby not only curtailing a production cost, but also reducing circuit complexity and providing a picture of excellent quality.

Example FIG. 12 illustrates a signal generation apparatus for generating a pingpong control signal for removal of a display offset in accordance with embodiments. Some parts of the apparatus illustrated in example FIG. 12 are the same as those illustrated in the apparatus of example FIG. 4. Therefore, the same parts will be denoted by the same reference numerals and a description thereof will be omitted. Frame recognizer 900 generates a frame recognition signal from a load signal or DIO signal which is a signal having a blank period for discrimination between frames, and outputs the generated frame recognition signal to PFC 902. For example, the frame recognition signal corresponds to the signal Q12SR illustrated in example FIG. 7. Frame recognizer 900 may be implemented by plurality of counters 502/1, 502/2, . . . , 502/n, first logic circuit 504, delay 512 and inverter 514 in the circuit illustrated in example FIG. 5, in order to generate a frame recognition signal. PFC 902 receives the frame recognition signal from frame recognizer 900, converts the received signal into a signal alternating at intervals of a certain number of frames and outputs the converted signal to PPC signal generator 460. For example, PFC 902 may convert the frame recognition signal into a signal alternating at intervals of one frame and output the converted signal to PPC signal generator 460, convert the frame recognition signal into a signal alternating at intervals of four frames and output the converted signal to PPC signal generator 460, or convert the frame recognition signal into a signal alternating at intervals of two frames and output the converted signal to PPC signal generator 460. Provided that PFC 902 converts the frame recognition signal into a signal alternating at intervals of two frames and outputs the converted signal to PPC signal generator 460, it will be implemented with two T flip-flops connected in series. In this case, the two T flip-flops perform the same functions as those of the two T flip-flops of second logic circuit 506 illustrated in example FIG. 5.

PLC 420 illustrated in example FIG. 12 receives a signal having the blank period, namely, the load signal LOAD and generates and outputs signals PLC1 and PLC2 each having a level alternately changing at intervals of a predetermined number of lines. The predetermined number of lines may be two lines or four lines depending on how to configure the panel. With the exception of this, PLC 420 illustrated in example FIG. 12 has the same function and configuration as those of PLC 420 illustrated in example FIG. 4. Reset signal generator 430 receives the frame recognition signal from frame recognizer 900 and generates a reset signal in a period from the end of the blank period until the input of the load signal LOAD of the next frame in response to the frame recognition signal. This reset signal is generated at intervals of one frame. Selector 440 generates a selection control signal through a comparison between POL signal polarities of the first line and second line using the POL signal generated from timing controller 400 and the frame recognition signal outputted from frame recognizer 900.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A signal generation apparatus for generating a pingpong control signal for removal of an offset of a liquid crystal display device, the signal generation apparatus comprising:
a pingpong frame controller (PFC) for generating and outputting a signal alternating at intervals of two frames using a signal having a blank period for discrimination between frames;
a pingpong line controller (PLC) for generating and outputting a signal alternating at intervals of two lines using the signal having the blank period; and
a pingpong control (PPC) signal generator for performing a logic operation with respect to the output signal from the PLC and the output signal from the PFC to generate the pingpong control signal.

2. The signal generation apparatus of claim 1, wherein the PFC comprises:
n counters connected in series and initialized by the signal having the blank period, each of the counters making a transition of a period (T) of a clock signal by (2ⁿ⁻¹−1) times, so that the counters convert the clock signal into a signal having a period of 2ⁿT and output the converted signal;
a first logic circuit for outputting a signal for recognition of the blank period in response to an output signal from an nth one of the n counters and the signal having the blank period; and
a second logic circuit for receiving the output signal from the first logic circuit, converting the received signal into the signal alternating at intervals of two frames and outputting the converted signal.

3. The signal generation apparatus of claim 2, wherein n is a positive number which is larger than a maximum period of the signal having the blank period depending on a resolution and frequency of the liquid crystal display device.

4. The signal generation apparatus of claim 2, wherein n is a positive integer satisfying the following equation:
(2ⁿ⁻¹−1)×T>max(Tₗᵢₙₑ₋ₜᵢₘₑ)
where max(Tₗᵢₙₑ₋ₜᵢₘₑ) signifies a maximum period of a line time, and T signifies the period of the clock signal.

5. The signal generation apparatus of claim 2, wherein n counters comprise n T flip-flops connected in series.

6. The signal generation apparatus of claim 2, wherein the first logic circuit comprises an SR flip-flop, the SR flip-flop receiving the output signal from the nth counter at a set terminal thereof and the signal having the blank period at a reset terminal thereof and outputting the blank period recognition signal at a positive output terminal thereof in response to the received signals.

7. The signal generation apparatus of claim 2, wherein the PFC further comprises a delay for delaying the signal having the blank period by a predetermined time and providing the delayed signal to the first logic circuit.

8. The signal generation apparatus of claim 2, wherein the PFC further comprises:
an inverter for inverting the signal having the blank period when the signal having the blank period is “0”; and
a delay for delaying the signal inverted by the inverter by a predetermined time.

9. The signal generation apparatus of claim 2, wherein the second logic circuit comprises two flip-flops connected in series.

10. The signal generation apparatus of claim 9, wherein the flip-flops are T flip-flops.

11. The signal generation apparatus of claim 1, wherein the PLC comprises:
a first logic device for receiving the signal having the blank period and outputting a positive output signal having a level alternately changing at intervals of one line, and a negative output signal which is an inverted signal of the positive output signal;
a second logic device for receiving the positive output signal outputted from the first logic device and outputting a first signal having a level alternating at intervals of two lines beginning with a third line; and
a third logic device for receiving the negative output signal outputted from the first logic device and outputting a second signal having a level alternating at intervals of two lines beginning with a second line.

12. The signal generation apparatus of claim 11, wherein each of the first, second and third logic devices is a T flip-flop.

13. The signal generation apparatus of claim 11, further comprising:
a selector for outputting a selection control signal through a comparison between POL signal polarities of a first line and a second line; and
a signal selector for selectively outputting any one of the first signal outputted from the second logic device or the second signal outputted from the third logic device in response to the selection control signal.

14. The signal generation apparatus of claim 1, further comprising a reset signal generator for receiving a signal for recognition of the blank period and generating a reset signal for initialization of the PLC at intervals of one frame.

15. The signal generation apparatus of claim 1, wherein the PPC signal generator receives the output signal from the PFC and the output signal from the PLC and exclusive-ORs the received signals.

16. The signal generation apparatus of claim 1, wherein the signal having the blank period is a load signal or digital input/output (DIO) signal.

17. A signal generation apparatus for generating a pingpong control signal for removal of an offset of a liquid crystal display device, the signal generation apparatus comprising:
a frame recognizer for generating a frame recognition signal from a signal having a blank period for discrimination between frames;
a pingpong frame controller (PFC) for converting the frame recognition signal into a signal alternating at intervals of a predetermined number of frames and outputting the converted signal;
a pingpong line controller (PLC) for generating and outputting a signal alternating at intervals of a predetermined number of lines using the signal having the blank period; and
a pingpong control (PPC) signal generator for performing a logic operation with respect to the output signal from the PLC and the output signal from the PFC to generate the pingpong control signal.

18. The signal generation apparatus of claim 17, further comprising a reset signal generator for generating a reset signal in a period from an end of the blank period until an input of the signal with the blank period of a next frame in response to the frame recognition signal from the frame recognizer, wherein the PLC is reset in response to the reset signal.

19. The signal generation apparatus of claim 17, wherein the PLC comprises:
a first logic device for receiving the signal having the blank period and outputting a positive output signal having a level alternately changing at intervals of one line, and a negative output signal which is an inverted signal of the positive output signal;
a second logic device for receiving the positive output signal outputted from the first logic device and outputting a first signal having a level alternating at intervals of two lines beginning with a third line; and
a third logic device for receiving the negative output signal outputted from the first logic device and outputting a second signal having a level alternating at intervals of two lines beginning with a second line.

20. The signal generation apparatus of claim 19, further comprising:
a selector for generating a selection control signal through a comparison between POL signal polarities of a first line and a second line using a POL signal and the frame recognition signal outputted from the frame recognizer; and
a signal selector for selectively outputting any one of the first signal outputted from the second logic device and the second signal outputted from the third logic device in response to the selection control signal.
